(19) United States
(12) Patent Application Publication
(10) Pub. No.: US 2015/0068373 A1
(43) Pub. Date: Mar. 12, 2015

(54) Continuous Rod Cutting System

(71) Applicant: Tiffany Armitage, Calgary (CA)

(72) Inventor: Tiffany Armitage, Calgary (CA)

(21) Appl. No.: 14/021,183

(22) Filed: Sep. 9, 2013

(51) Int. Cl. B23D 21/00

(52) U.S. Cl. CPC B23D 21/00
USPC 83/13; 83/436.3

(57) ABSTRACT

The continuous rod cutting system has a base; a rod path; a shear cutting unit mounted to the base and having a cutting jaw operable to cut across the rod path; and two pinch roller units mounted to the base, each on a respective side of the cutting jaw, each having at least one corresponding pair of rollers aligned with the rod path, on opposite sides of the rod path. The rollers being movable relative one another of the corresponding pair, into and out of engagement with the rod path, and each pair of rollers being selectively operable into cooperating opposed rotation in both directions, independently of said relative movement operability, for moving a rod engaged therebetween in a corresponding direction along the rod path and stopping and holding the rod for subsequent cutting by the shear cutting unit.

### CROSS-REFERENCE TO RELATED APPLICATIONS

This application claims priority to co-pending application Ser. No. 61/990,032 filed on Sep. 10, 2012, the contents of which are fully incorporated herein.

### FIELD

The improvements generally relate to the field of oil production equipment, and more particularly relates to the operation of handling and cutting continuous rods used in oil well pumps.

### BACKGROUND

During recent years, continuous rods have become more and more popular compared to traditional sucker rods to activate the pumps located at the bottom of oil wells. Typical sucker rods consisted of a long string of 20 to 30 foot steel rods (e.g. ˜200) which were assembled to one another at the well site and used to connect the pump in the well to the pump jack (horse head) located at ground level. Continuous rods consist of a single rod of the same length and can offer significantly increased durability, in addition to being usable both for progressive cavity pumping and reciprocating cavity pumping. Several forms of equipment have been developed in recent years to address the issues pertaining to handling such rods, and these include 20 feet diameter spools which are used to coil the continuous rod for transport. On site, the continuous rod is uncoiled from the spool until the desired length is reached, at which time the rod is cut. Cutting the rod typically requires over 100 000 PSI of shear stress while maintaining a firm grasp on the rod which can be spring loaded with an impressive amount of energy. Although the existing equipment was satisfactory to a certain degree, there remained room for improvement, particularly for the steps of handling and cutting such rods.

### SUMMARY

In accordance with one aspect, there is provided a reversible continuous rod cutting system comprising: a base; a rod path; a shear cutting unit mounted to the base and having a cutting jaw operable to cut across the rod path; and two pinch roller units mounted to the base, each on a respective side of the cutting jaw, each having at least one corresponding pair of rollers, the rollers of each pair being aligned with the rod path, on opposite sides of the rod path, each pair of rollers being operable to move a first one of the rollers relative a second one of the rollers into and out from engagement with the rod path, and each pair of rollers being selectively operable into cooperating opposed rotation in both directions, independently of said relative movement operability, for moving a rod engaged therebetween in a corresponding direction along the rod path and stopping and holding the rod for subsequent cutting by the shear cutting unit.

In accordance with another aspect, there is provided a method of cutting a continuous rod using a system having a base, a rod path, a shear cutting unit mounted to the base and having a cutting jaw operable to cut across the rod path and two pinch roller units mounted to the base, each on a respective side of the cutting jaw, each having at least one corresponding pair of rollers, the rollers of each pair being aligned with the rod path, on opposite sides of the rod path, said method comprising: positioning the continuous rod in the rod path; moving a first one of the rollers of at least one of the pairs relative a second one of the rollers of the corresponding pair into engagement with the continuous rod; rotating the first and second engaged rollers into cooperating opposed rotation, thereby moving the continuous rod along the rod path; stopping the cooperating opposed rotation of the first and second engaged rollers when a selected portion of the continuous rod is aligned with the cutting jaw; and cutting the continuous rod using the shear cutting unit while the first and second rollers hold the selected portion of the continuous rod in alignment with the cutting jaw.

Many further features and combinations thereof concerning the present improvements will appear to those skilled in the art following a reading of the instant disclosure.

### DESCRIPTION OF THE FIGURES

In the figures,

FIG. 1 is an oblique view of an example of a continuous rod cutting system;

FIGS. 2 to 4 are left side, front, and rear elevation views thereof, respectively;

FIG. 5 is another oblique view, taken partially from below;

FIG. 6 is another oblique view thereof, in a deployed state;

FIG. 7 shows an example of a working configuration; and

FIG. 8 is a hydraulic schematic thereof.

### DETAILED DESCRIPTION

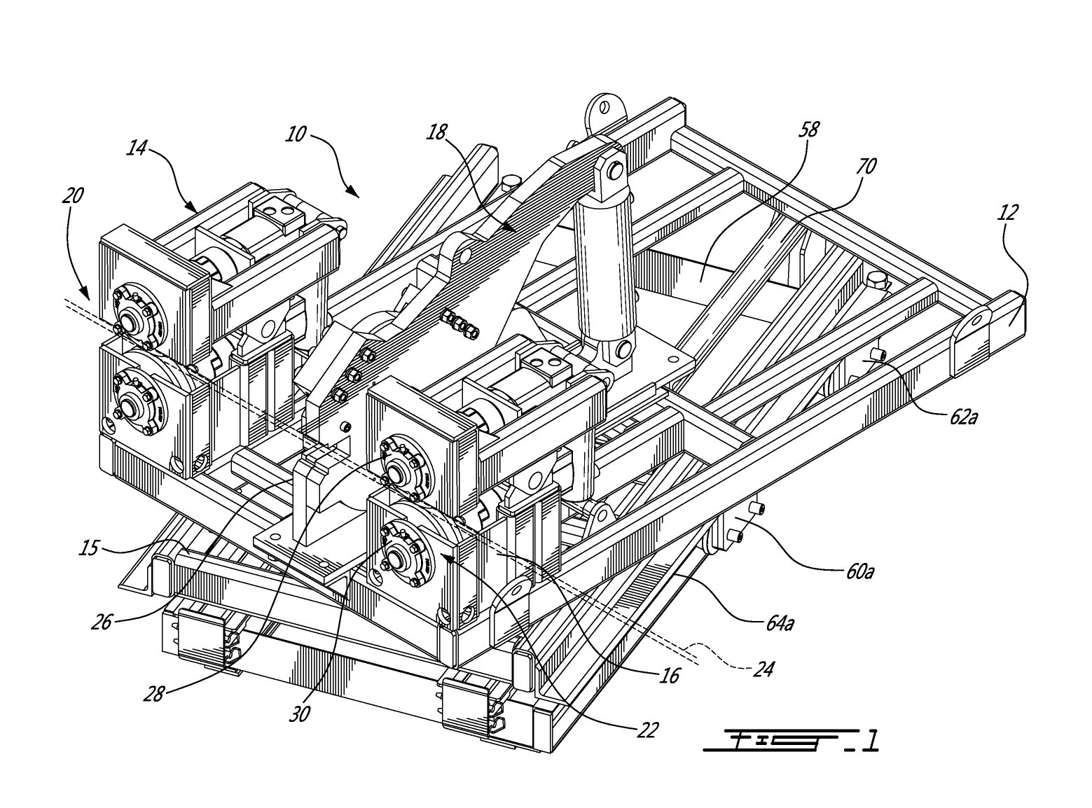

FIG. 1 shows an example of a continuous rod cutting system 10. The system 10 can generally be seen to include a base 12 onto which two pinch roller units 14, 16 are mounted on corresponding sides of a shear cutting unit 18. The pinch roller units 14, 16 each include a corresponding pair of rollers 20, 22 associated with a mechanism which makes them both operable to move toward and away from one another to selectively engage a continuous rod located therebetween. The rollers 28, 30 of each pair and operable to rotate in cooperating opposite angular directions when engaged, to move the continuous rod in a selected one of two opposite directions. The illustrated example offers a high degree of versatility, and is reversible in the sense that it can receive a continuous rod from either side. Moreover, in this specific embodiment, the base is pivotally mounted on an extendible frame portion 15 in a manner to provide a high degree of versatility.

The path which the continuous rod follows as it is moved by the rollers will be referred to herein as the continuous rod path 24, for later reference. The continuous rod path 24 crosses a cutting jaw 26 of the shear cutting unit 18, where the continuous rod is cut at the desired length.

During operation, a continuous rod can be positioned in the continuous rod path 24 from either side and engaged by one or both pairs of rollers 20, 22, which are then rotatably operated to move a selected length of rod. When the selected portion of the continuous rod is aligned with the cutting jaw 26, the pairs of rollers 20, 22 can be stopped to hold the continuous rod into a fixed position relative the cutting jaw 26 for a period of time during which the shear cutting unit 18 is operated to cut the continuous rod at the selected portion, or desired length. The pairs of rollers 20, 22, each then holding a corresponding section of continuous rod material, can then independently be operated into cooperating rotation in either angular direction, or operated into relative movement to disengage a corresponding one, or both, of the continuous rod sections. This operation can be user-controlled via a control panel, remote control, smart phone application, or other appropriate interface for instance.

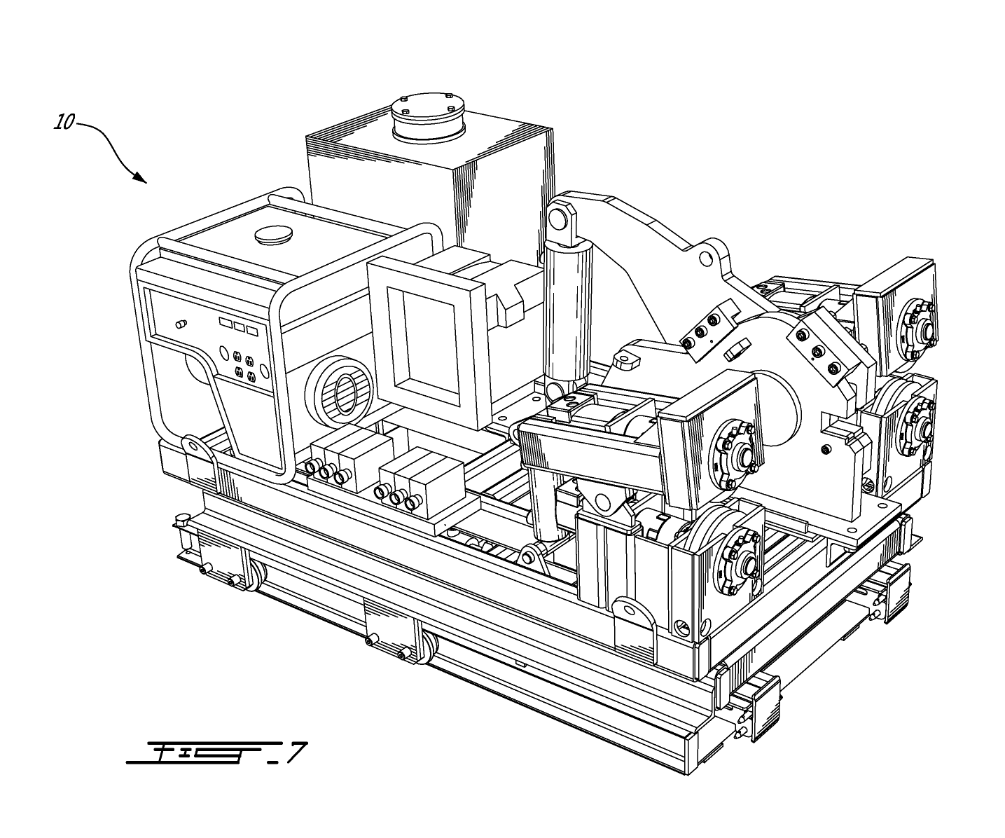

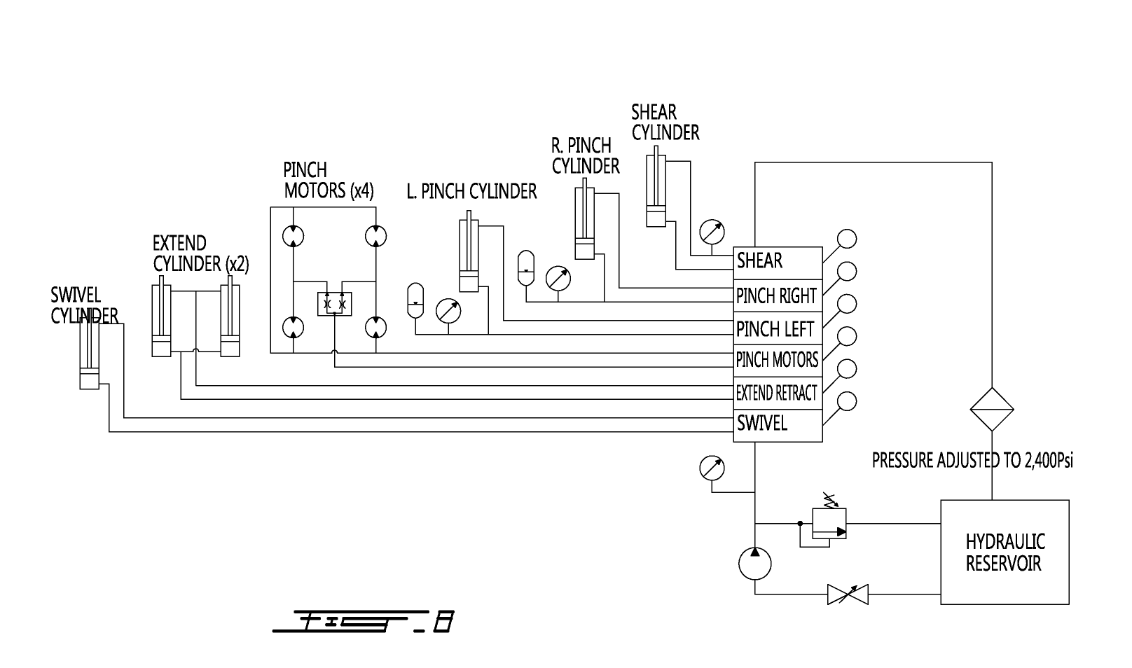

Each of these functions (i.e. pinch-release (2); forward-reverse cooperation rotation (2); cut-release; pivoting and extension-retraction, both of which will be detailed further below) can be hydraulically powered, for instance. An example of a system equipped with a hydraulic power unit is shown in FIG. 7, the example hydraulic circuit of which is provided at FIG. 8. Though the pictured prototype is made fully independent, equipped with a gas generator set, a hydraulic power pack and an electric bypass for interior use, it will be understood that alternate embodiments are possible, as will be understood by persons skilled in the art.

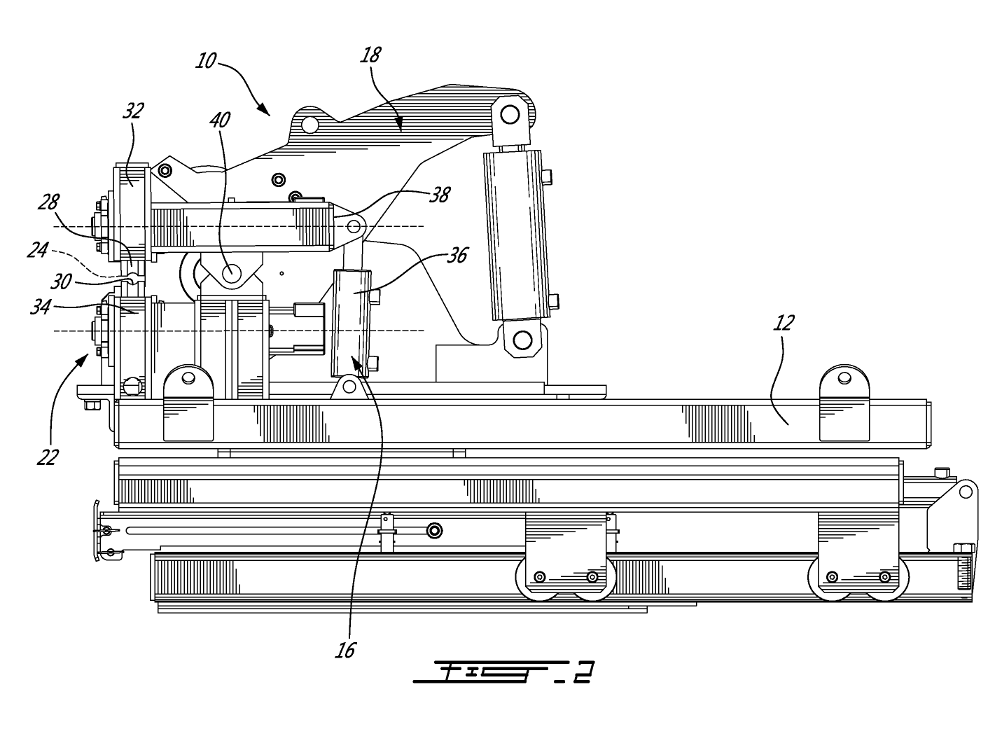

Turning to FIG. 2, the details of the pinch roller units 14, 16 will now be provided. In this particular example, both pinch roller units 14, 16 are identical, and only one will therefore be described in detail. In this embodiment, the pinch roller units 14, 16 each include a single pair of rollers 28, 30. Each roller 28, 30 is received in a corresponding housing 32, 34 in which it is hydraulically powered for rotation according to the schematic of FIG. 7. The bottom housing 34 is fixed to the base 12, whereas the upper housing 32 is pivotally mounted to the bottom housing 34. A roller hydraulic cylinder 36 is positioned between the base 12 and a distal end 38 of the upper housing 32, the distal end 38 being located opposite the upper roller 28 relative the pivot axis 40. Henceforth, when the roller hydraulic cylinder 36 is activated, the upper roller 32 is moved correspondingly towards, or away from the lower roller 30 to respectively engage (pinch) or release the continuous rod. When the rollers 28, 30 are in the engaged configuration, both their axes are oriented horizontally, perpendicular to the continuous rod path 24 which also extends horizontally. It will be understood that the above example is provided for illustrative purposes only, and that alternate embodiments can include roller housings which slide (e.g. vertically) relative to one another rather than pivot, and/or more than one pair of rollers on either side of the shear cutting unit, for example.

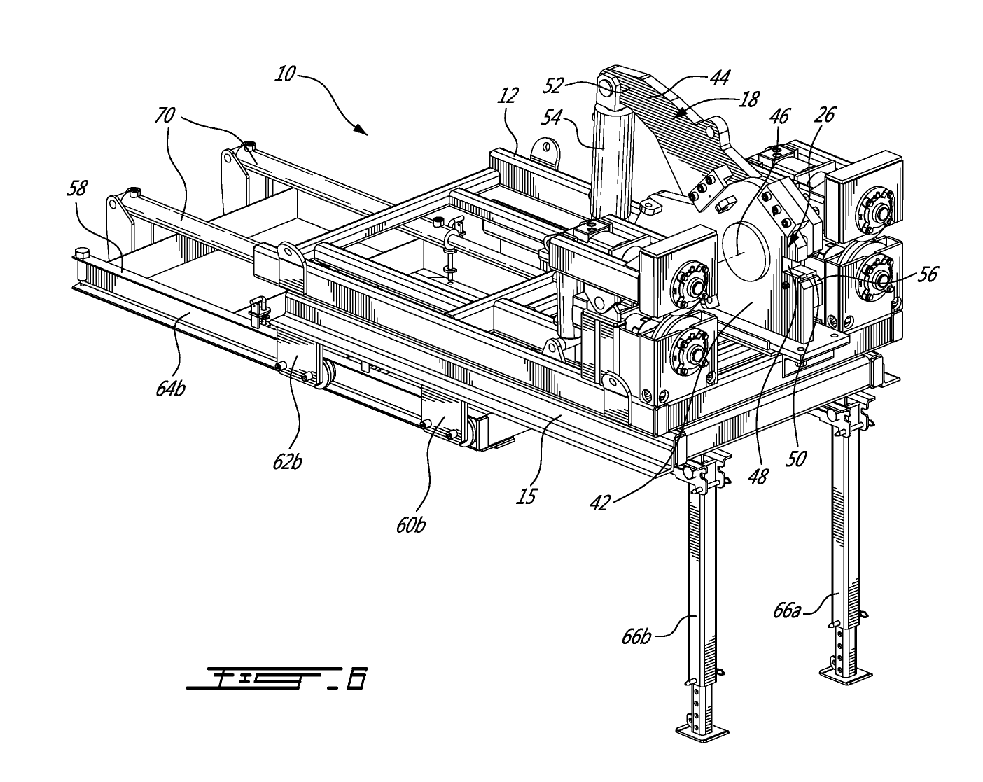

Turning now to FIGS. 1 and 6, the details of the shear cutting unit 18 will now be provided. In this particular example, the cutting jaw 26 of the shear cutting unit 18 is located at the front, to receive the continuous rod path 24, and the shear cutting unit 18 includes a first portion 42 which is made integral to the base 12 and a second portion 44 which is pivotally mounted relative the first portion, about a pivot axis 46. The first portion 42 includes a first, fixed half 48 of the cutting jaw 26 and the second portion 44 includes a second, mobile half 50 of the cutting jaw 26, and a lever arm 52. A cutting hydraulic cylinder 54 fixed to the base 12, is used to activate the cutting jaw 26 by moving the lever arm 52. A guide 56 is also provided in this case, in the shape of a horizontally oriented “V”, to ease the task of positioning the continuous rod into the rod path 24.

The mobile half 50 of the cutting jaw 26 is positioned at a first distance from the pivot axis 46, whereas the lever arm 52 extends to a second distance from the pivot axis 46. The second distance from the pivot axis 46 is significantly greater than the first distance from the pivot axis 46, allowing to leverage force exerted onto the end of the lever arm 52 and concentrate it at the cutting jaw 26. For the purpose of illustration, cutting a typical continuous rod can require between 130 000 and 140 000 PSI. Leveraging the force using a lever arm 52 such as illustrated can significantly reduce the costs and constraints related to the hydraulic cylinder used.

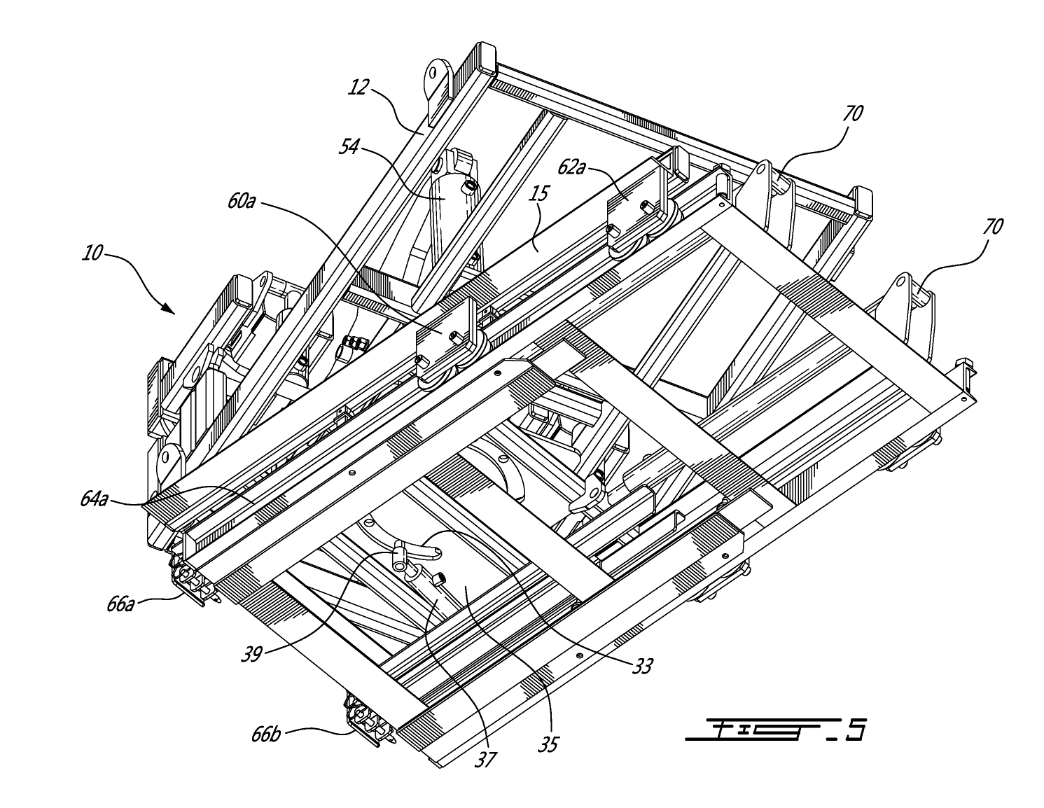

Comparing FIGS. 1 and 5 to FIGS. 3 and 4, it will be understood how the base 12 can be pivoted relative to an extendible frame portion 15. This pivoting feature is optional, but can be very useful in aligning the cutting rod path 24 tangentially with the large spools continuous rods are typically wrapped around. In this particular embodiment, the base 12 is made pivotal by interfacing it with the extendible frame portion via a pivoting plate 35 having an arc-shaped guide path 33 formed therein. One or more swivel hydraulic cylinders 37 can have one end mounted to the extendible frame portion 15, and the other end mounted to the pivotal base 12 via a guide pin 39 which extends across, and is guided by, the arc-shaped guide path 33. The pivoting mechanism shown in FIG. 5 is only an example and it will be understood that the exact pivoting mechanism used in alternate embodiments, if any, can be different than the one shown herein and described above.

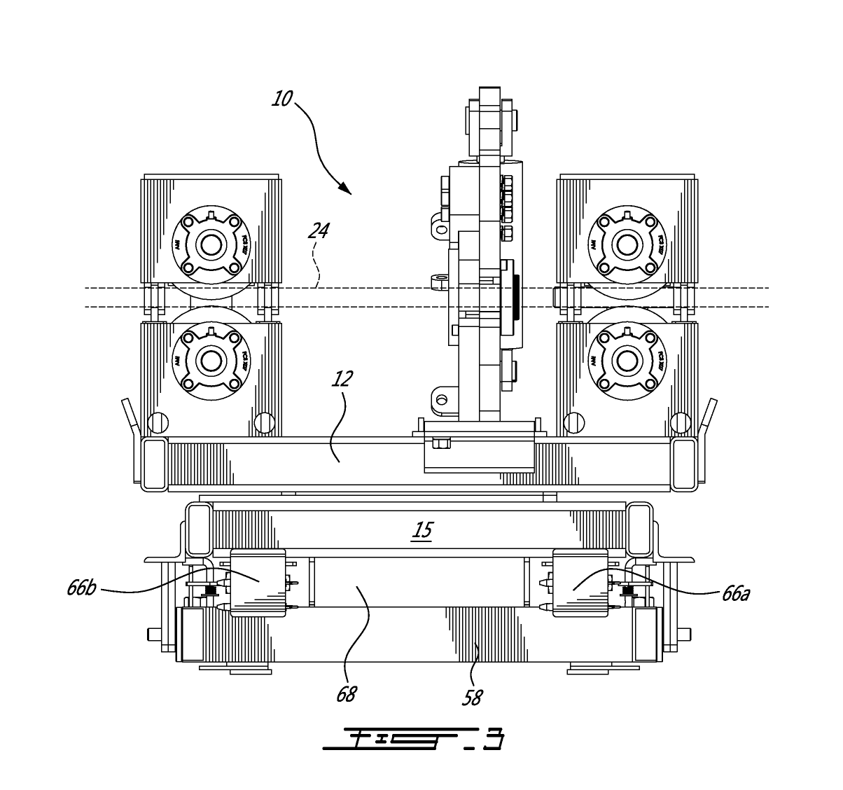

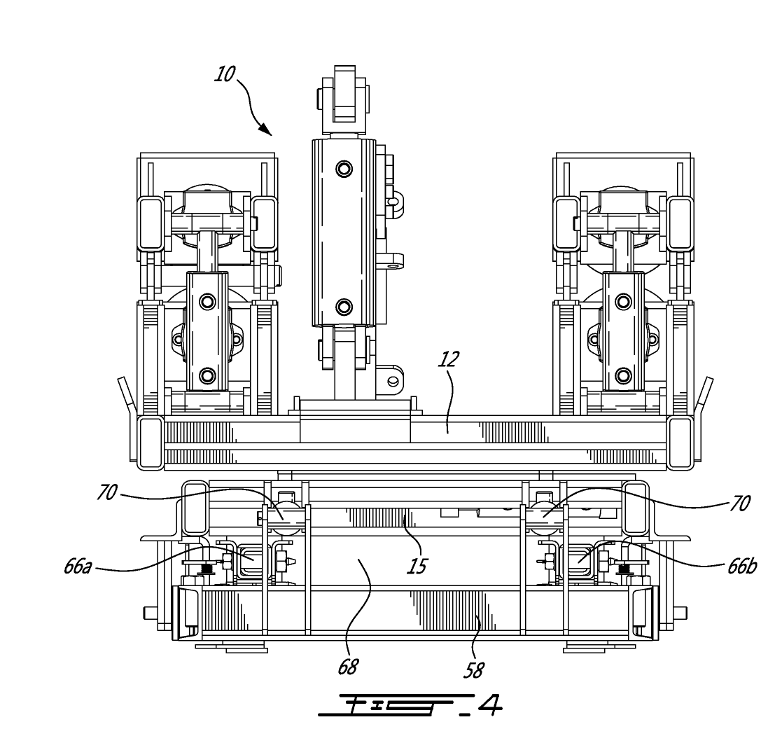

Comparing FIG. 1 to FIG. 6, the deployment of the continuous rod cutting system 10 will now be described. In this embodiment, the continuous rod cutting system 10 includes a deployment mechanism. The deployment mechanism includes a fixable frame portion 58 onto which the extendible frame portion 15 is slidably mounted by means of two lengthwisely spaced pairs of rollers 60a, 60b, 62a, 62b engaged with a corresponding rail 64a, 64b on each side of the continuous rod cutting system 10. The front of the extendible frame portion 15, which coincides with the continuous rod path 24, can thus be slid a significant distance from the fixable frame portion 58. Two foldable legs 66a, 66b are used to support the weight of the cantilevered portion during operation, and these are hinged to the front of the extendible frame portion 15, on opposite sides, and can be folded under the extendible frame portion 15 when unused. A spacing 68, such as best seen in FIGS. 3 and 4, can be provided between the extendible frame portion 15 and the fixable frame portion 58 into which the folded legs 66a, 66b can be nested when the extendible frame portion 15 is retracted onto the fixable frame portion 58. The sliding of the extendible frame portion 15 relative the fixable frame portion 58 can be powered via a roll out hydraulic cylinder 70 as illustrated.

It will be noted that the deployment mechanism described above is optional. It can be used to provide greater versatility and portability of the continuous rod cutting system 10, such as by allowing its mounting to the box of a pick-up truck, for instance. Alternately, the deployment mechanism can be omitted and the base be mounted directly to a reel transport deck of a semi-truck, to name one alternate example. If the pivoting mechanism is omitted in an embodiment, the base 12 can be slidably mounted directly to the fixable frame portion 58, for instance.

As can be seen from the above, the examples described above and illustrated are intended to be exemplary only. The scope is indicated by the appended claims.

What is claimed is:

1. A reversible continuous rod cutting system comprising:
a base;
a rod path;
a shear cutting unit mounted to the base and having a cutting jaw operable to cut across the rod path; and
two pinch roller units mounted to the base, each on a respective side of the cutting jaw, each having at least one corresponding pair of rollers, the rollers of each pair being aligned with the rod path, on opposite sides of the rod path, each pair of rollers being operable to move a first one of the rollers relative a second one of the rollers into and out from engagement with the rod path, and each pair of rollers being selectively operable into cooperating opposed rotation in both directions, independently of said relative movement operability, for moving a rod engaged therebetween in a corresponding direction along the rod path and stopping and holding the rod for subsequent cutting by the shear cutting unit.

2. The system of claim 1 wherein the rod path extends in a horizontal orientation and the rollers each have an axis oriented horizontally, perpendicular to the orientation of the rod path, when in engagement with the rod path.

3. The system of claim 1 wherein the shear cutting unit includes a first portion made integral to the base, having a first half of the cutting jaw, and a second portion rotatable relative the first portion about a pivot axis, the second portion having a second half of the cutting jaw, and a lever arm extending from the pivot axis at a distance at least twice greater than the distance between the second half of the cutting jaw and the pivot axis, the shear cutting unit being operable to cut by moving the lever arm.

4. The system of claim 1 further comprising a hydraulic power unit mounted to the base and powering the operability of the pinch roller units and the shear cutting unit.

5. The system of claim 4 wherein the relative movement operability of the rollers of the two pinch roller units includes the use of independent hydraulic accumulators for each roller pair.

6. The system of claim 1 wherein the base is pivotally mounted to a fixed frame and can be operated to swivel around a vertical pivot axis.

7. The system of claim 1 wherein the base is slidingly mounted to a fixed frame and further comprises foldable legs deployable from under a portion of the base for support when said portion of the base is slid away from the fixed frame.

8. A method of cutting a continuous rod using a system having a base, a rod path, a shear cutting unit mounted to the base and having a cutting jaw operable to cut across the rod path and two pinch roller units mounted to the base, each on a respective side of the cutting jaw, each having at least one corresponding pair of rollers, the rollers of each pair being aligned with the rod path, on opposite sides of the rod path, said method comprising:
positioning the continuous rod in the rod path;
moving a first one of the rollers of at least one of the pairs relative a second one of the rollers of the corresponding pair into engagement with the continuous rod;
rotating the first and second engaged rollers into cooperating opposed rotation, thereby moving the continuous rod along the rod path;
stopping the cooperating opposed rotation of the first and second engaged rollers when a selected portion of the continuous rod is aligned with the cutting jaw; and
cutting the continuous rod using the shear cutting unit while the first and second rollers hold the selected portion of the continuous rod in alignment with the cutting jaw.

9. The method of claim 8 wherein said steps of moving, rotating and stopping are done collectively by at least two pairs of rollers, with at least one pair on each side of the cutting jaw.

10. The method of claim 9 wherein during said engagement with the continuous rod, each engaged pair of rollers exerts the same pinching force against the continuous rod, independently of the distance between the rollers of the corresponding pair.

11. The method of claim 8 wherein the step of cutting includes rotating a first portion of the cutting jaw relative a second portion of the cutting jaw.
